(19) United States
(12) Patent Application Publication
(10) Pub. No.: US 2010/0025558 A1
(43) Pub. Date: Feb. 4, 2010

(54) POLE UNIT FOLDING MECHANISM FOR WHEELED DISTANCE MEASURING DEVICE

(76) Inventor: Yi-Wen Tang, Taichung (TW)

Correspondence Address: Yi-Wen Tang, No.37-2, Ching Dau 1st Street, Taichung, 404, omitted

(21) Appl. No.: 12/184,251

(22) Filed: Aug. 1, 2008

(51) Int. Cl. F16M 13/00

(52) U.S. Cl. 248/514

(57) ABSTRACT

A pole unit for a wheeled distance measuring device includes a first tube having a first pivotable portion and a first engaging portion extending radially outward therefrom respectively. A second tube has a second pivotable portion and a second engaging portion extending radially outward therefrom in two opposite directions. The second pivotable portion is pivotably connected to the first pivotable portion. A third tube and a fourth tube respectively connected to the first and second tubes respectively. A first connection member is connected to the second tube and has a second hook which is hooked with the first engaging portion. A connection mechanism has a second connection member pivotably connected to the first tube, and a third connection member which is removably connected with the first connection member so as to allow the first and second tubes to be pivotable.

### FIELD OF THE INVENTION

The present invention relates to a wheeled distance measuring device, and more particularly, to a pole unit folding mechanism for the distance measuring device.

### BACKGROUND OF THE INVENTION

A conventional distance measuring device is disclosed in U.S. Pat. No. 7,040,036 to Hui Chen Wang who is the wife of applicant and includes a wheel rotatably connected to a pole unit and a measuring unit is connected to a side of the wheel. The wheel includes a radius and rolls against a surface and the number of revolutions of the wheel can be counted by a counter in the measuring unit so as to obtain the distance that the wheel travels. A handle is connected to the other end of the pole unit and includes a brake key and an initialization key, two respective cables are connected to the brake key and the initialization key so as to brake the wheel and initialize the counter.

The pole unit is composed of multiple tubes and the mediate portion of the pole unit includes two sections and a hooking member is connected to the first section. The hooking member hooks to the second section to extend the pole unit as a straight pole. When folding the pole unit, the hooking member is disengaged from the second section to shorten the length of the pole unit.

However, the hooking portions where the connection of the hooking member occupies is a large area which is easily to be touched unintentionally by the user or any un-expect impact and the hooking member could be disengaged from the second section. Once the hooking member is disengaged from the second section, the measuring process is affected.

The present invention intends to provide a folding mechanism for a wheeled distance measuring device and the folding mechanism includes two different connection structures to ensure the locked position of the pole unit.

### SUMMARY OF THE INVENTION

The present invention relates to a pole unit for a wheeled distance measuring device and comprises a first tube having a first pivotable portion and a first engaging portion extending radially outward therefrom respectively. Two first pivots extend radially from the first tube in a direction other than directions of the first pivotable portion and the first engaging portion. A second tube has a second pivotable portion and a second engaging portion extending radially outward therefrom. The second pivotable portion are pivotably connected to the first pivotable portion. The second tube has a second engaging portion which is located corresponding to the first engaging portion. A third tube is connected with the first tube and a fourth tube is connected with the second tube.

A first connection member is connected to the second tube and has a second hook which is hooked with the first engaging portion. The first connection member has a first block on a top thereof and a space is defined between the first block and the first tube. A connection mechanism has a second connection member and a third connection member, wherein the second connection member has two arms which are connected to the two first pivots. A second block is connected between the two arms and has a first recess. The third connection member is engaged with the first recess and movable within the space so as to control the pivotable connection of the first and second tubes.

The primary object of the present invention is to provide a folding mechanism for the pole unit of a wheeled distance measuring device, wherein the pivotable connection is protected by the connection mechanism so as to avoid from unintentional disengagement happens during using the wheeled distance measuring device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pole unit folding mechanism of the present invention;

FIG. 2 is a perspective view of the pole unit folding mechanism of the present invention;

FIG. 3 is a plan view to show the pole unit folding mechanism of the present invention;

FIG. 4 is a cross sectional view, taken along line A-A in FIG. 3;

FIG. 5 is a side cross sectional view to show that the third connection member is pulled upward to disengage from the first connection member;

FIG. 6 is a side cross sectional view to show that the third connection member is pivoted away from the first connection member;

FIG. 7 is a cross sectional view to show that the pole unit is folded;

FIG. 8 is a perspective view to show that the pole unit is folded;

FIG. 9 is a perspective view to show the wheeled distance measuring device with the folding mechanism of the present invention;

FIG. 10 is a perspective view to show the second embodiment of the folding mechanism of the present invention;

FIG. 11 is an exploded view to show the third embodiment of the pole unit folding mechanism of the present invention;

FIG. 12 is a perspective view of the pole unit folding mechanism of the present invention in FIG. 11;

FIG. 13 is an exploded view to show the fourth embodiment of the pole unit folding mechanism of the present invention;

FIG. 14 is a perspective view of the pole unit folding mechanism of the present invention in FIG. 13;

FIG. 15 is a plan view to show the pole unit folding mechanism of the present invention in FIG. 13;

FIG. 16 is a cross sectional view, taken along line A-A in FIG. 15, and

FIG. 17 is a side cross sectional view to show that the third connection member is pulled upward to disengage from the first connection member by pivoting the fifth connection member.

### DETAILED DESCRIPTION OF THE PREFERRED EMBODIMENT

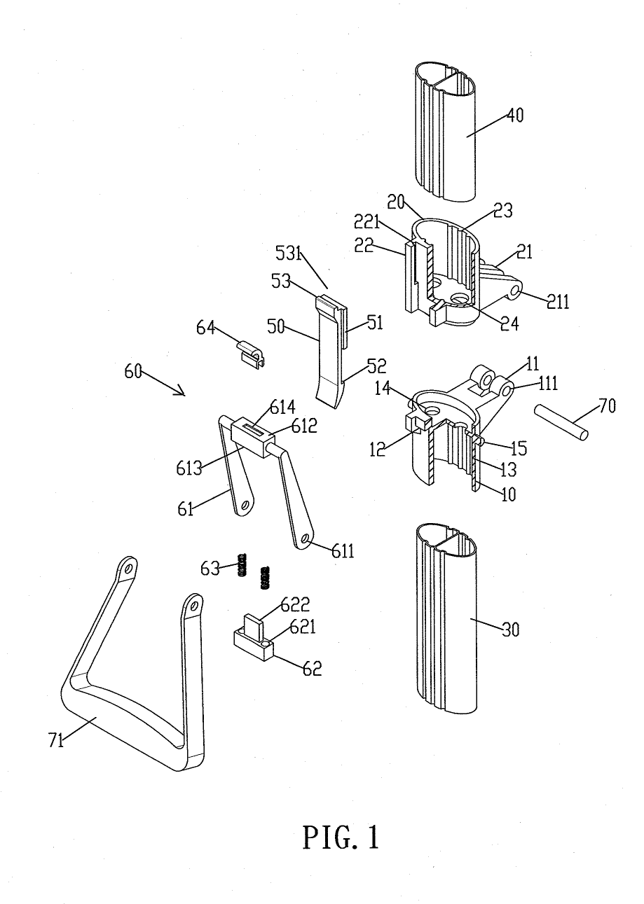

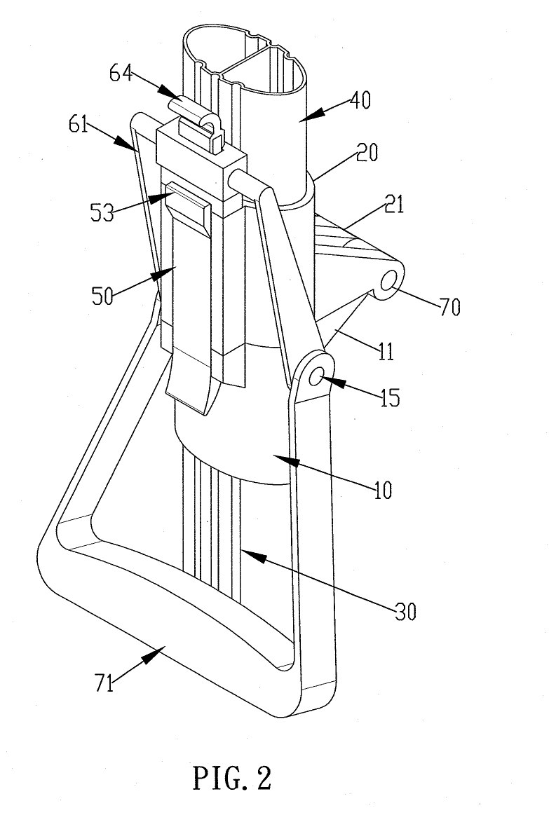

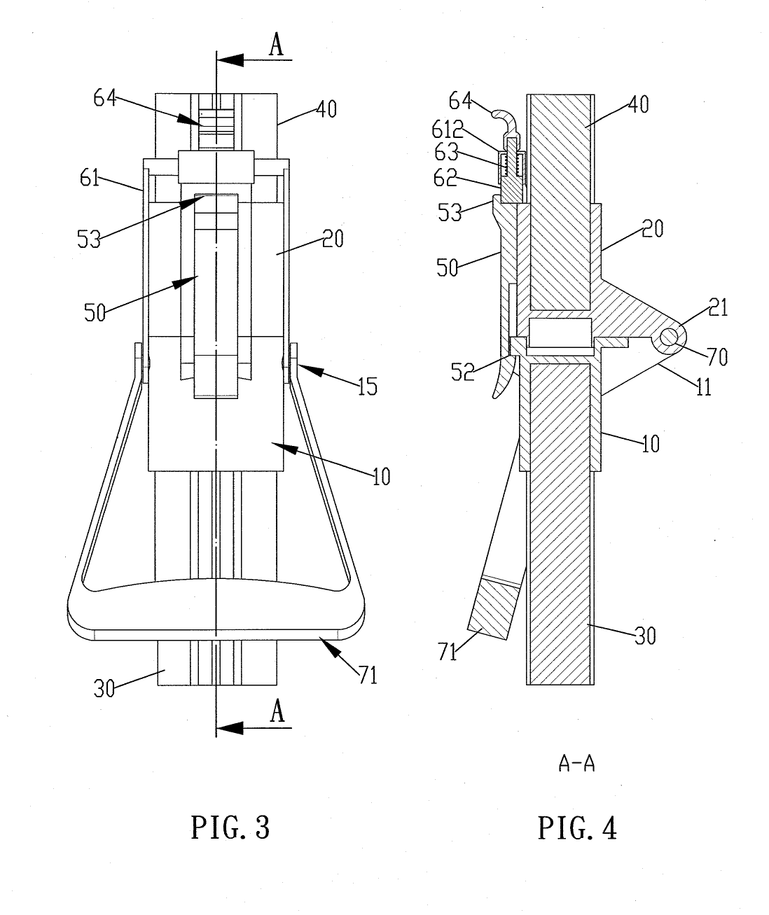

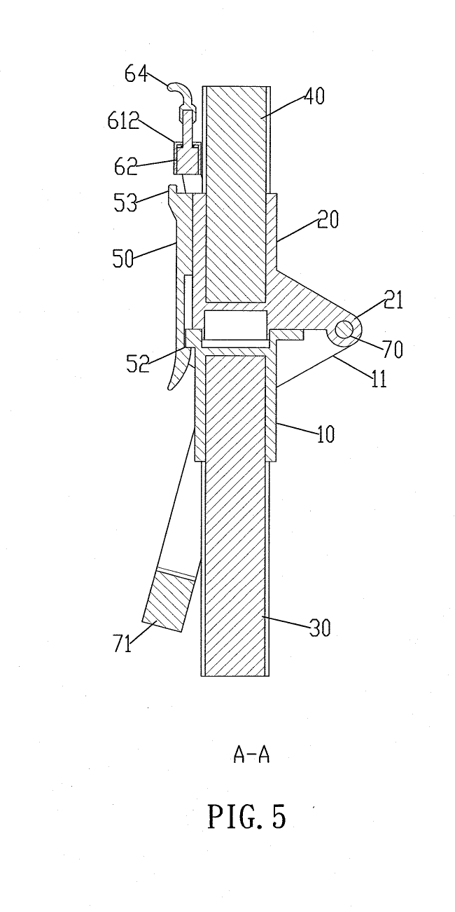

Referring to FIGS. 1 to 4 and 9, the pole folding mechanism of the present invention is cooperated with a wheeled distance measuring device which comprises a wheel and a front fork is connected to the wheel. A measuring unit is connected to a top of the front fork and includes a counter for counting number of revolutions of the wheel and an initialization unit which is able to set the counter to be zero. A pole unit is connected to the front fork and a handle is connected to a top of the pole unit.

The pole unit comprises a first tube 10, a second tube 20, a third tube 30 and a fourth tube 40, wherein the third tube 30 is connected with the front fork, the first tube 10 is connected between the second and third tubes 20, 30, and the fourth tube 40 is connected to the second tube 20. The first tube 10 has a first pivotable portion 11 and a first engaging portion 12 extending radially outward therefrom respectively in two opposite directions. Two first pivots 15 extend radially from the first tube 10 in two directions other than the directions of the first pivotable portion 11 and the first engaging portion 12. The first pivotable portion 11 of the first tube 10 includes a first passage 111 and the first tube 10 further includes a first groove 13 defined axially in an inner periphery thereof. Two first holes 14 are defined through a top of the first tube 10 and communicate with the first groove 13.

The second tube 20 has a second pivotable portion 21 and a second engaging portion 22 extending radially outward therefrom in two opposite directions. The second pivotable portion 21 has a second passage 211 and is pivotably connected to the first pivotable portion 11 by extending a first pin 70 through the first and second passages 111, 211 to pivotably connect the first tube 10 and the second tube 20. The second engaging portion 22 is located corresponding to the first engaging portion 12. The second tube 20 includes a second groove 23 defined axially in an inner periphery thereof and two second holes 24 are defined through a bottom of the second tube 20. The two second holes 24 communicate with the second groove 23, the first and second grooves 13, 23 are in communication with each other and the first and second holes 14, 24 are located in alignment with each other. The third tube 30 has a rail on outside thereof so as to be engaged with the first groove 13 and the fourth tube 40 has a rail on outside thereof so as to be engaged with the second groove 23. The second engaging portion 22 has the same length as the second tube 20 and includes two engaging slots 221.

A first connection member 50 is connected to the second tube 20 and has a first hook 51 which is hooked to the engaging slots 221 of the second engaging portion 22, and a second hook 52 which is hooked with the first engaging portion 12 on the first tube 10. The first connection member 50 further has a first block 53 on a top thereof and a space 531 is defined between the first block 53 and the first tube 10.

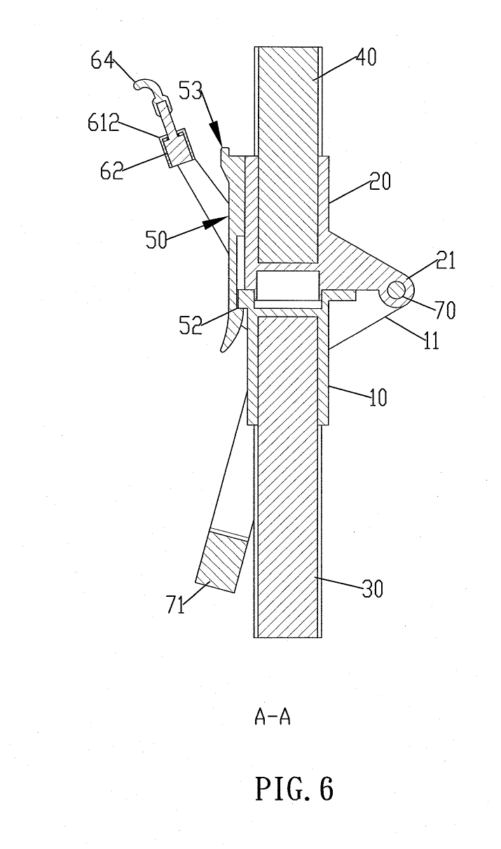

A connection mechanism 60 has a second connection member 61 and a third connection member 62, wherein the second connection member 61 has two arms and each arm has a first through hole 611. The two first pivots 15 are engaged with the two first through holes 611 in the two arms. A second block 612 is connected between the two arms and has a first recess 613 in an underside thereof and a second recess 614 is defined in a top of the second block 612. The second recess 614 is smaller than the first recess 613, and the first and second recesses 613, 614 are in communication with each other. The third connection member 62 is movably located within the space 531. Two notches 621 are defined in a top of the third connection member 62 and a protrusion 622 is located between the two notches 621. The protrusion 622 extends through first and second recesses 613, 614 of the second block 612. Two springs 63 are engaged with the two notches 621 and contact an inner end of the first recess 613 so as to push the third connection member 62 toward the first connection member 50. A fourth connection member 64 is fixed on the protrusion 622 on the third connection member 62, and contacts a top of the second block 612. The third connection member 62 is pulled to disengage from the first connection member 50 by pulling the fourth connection member 64 upward as shown in FIG. 5. A handle 71 is connected to the pivots 15 on the first tube 10 and includes two arms which are located on outside of the second connection member 61.

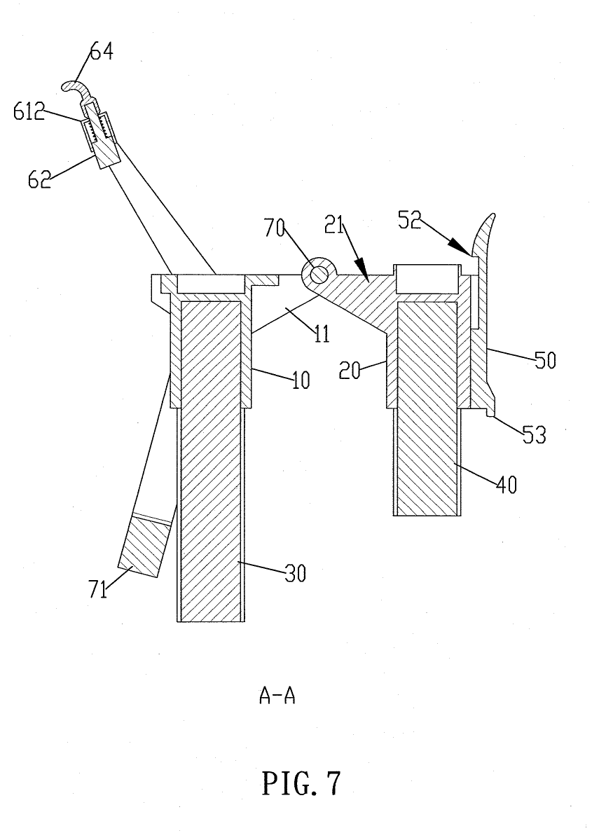

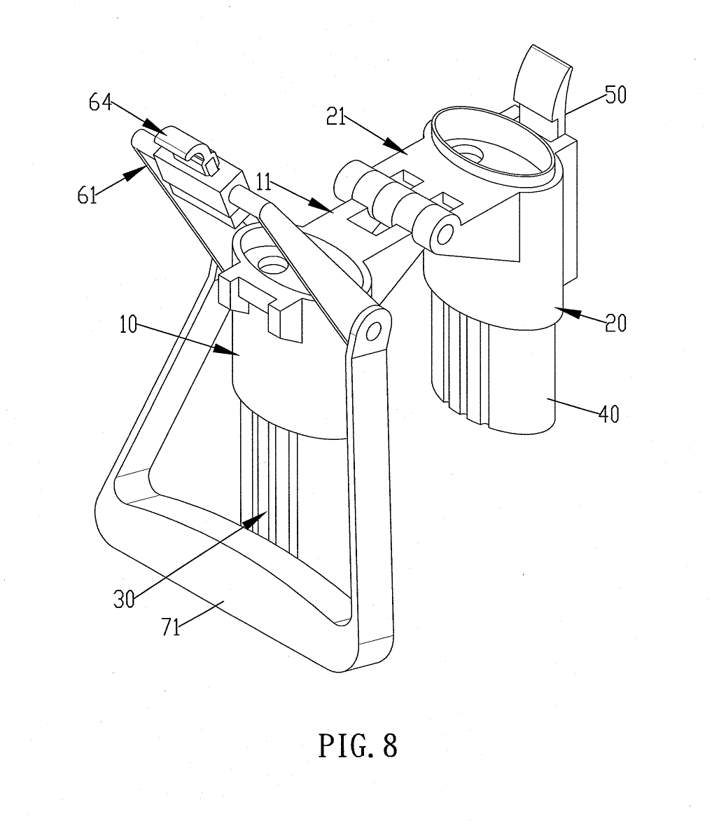

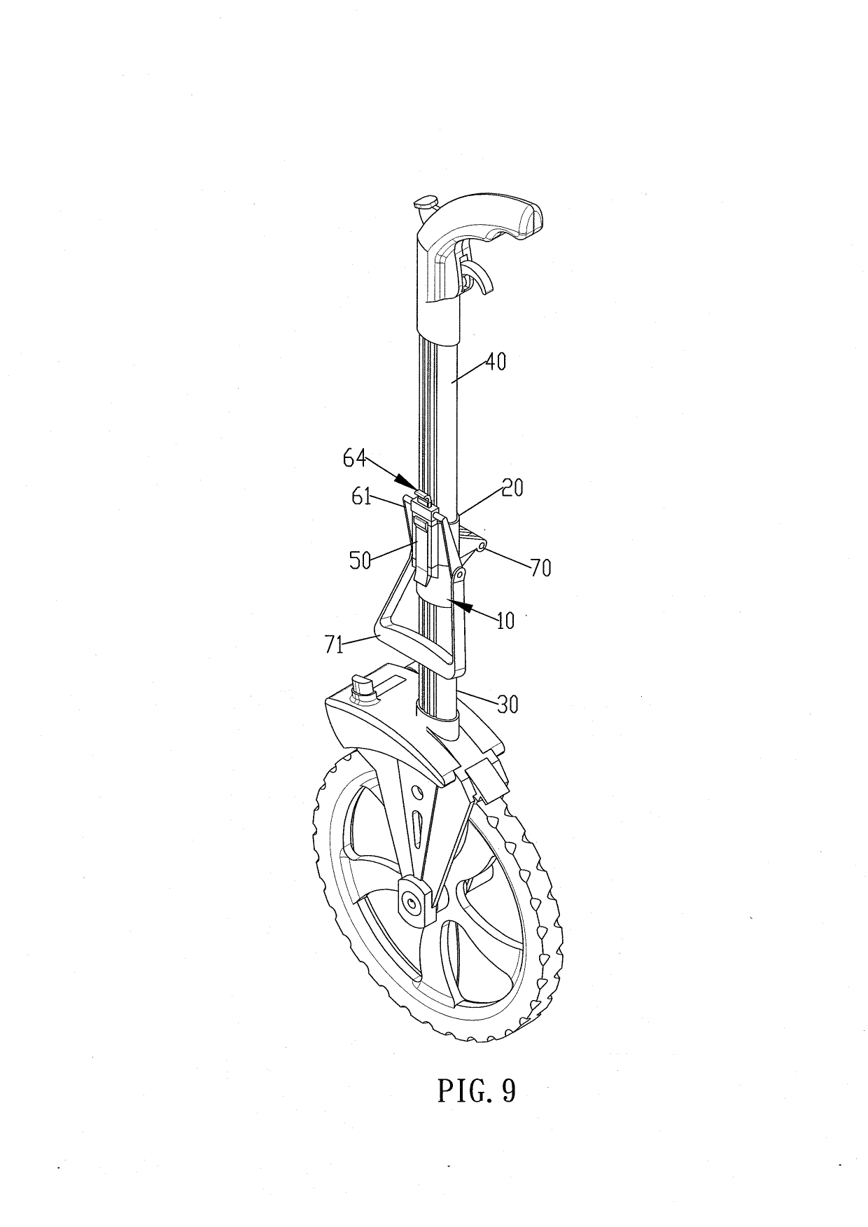

Referring to FIGS. 6 to 8, when the third connection member 62 is disengaged from the first connection member 50 by pulling the fourth connection member 64 upward, the first and second tubes 10, 20 are pivoted about the first pin 70 as shown in FIG. 8 so as to shorten the length of the pole unit.

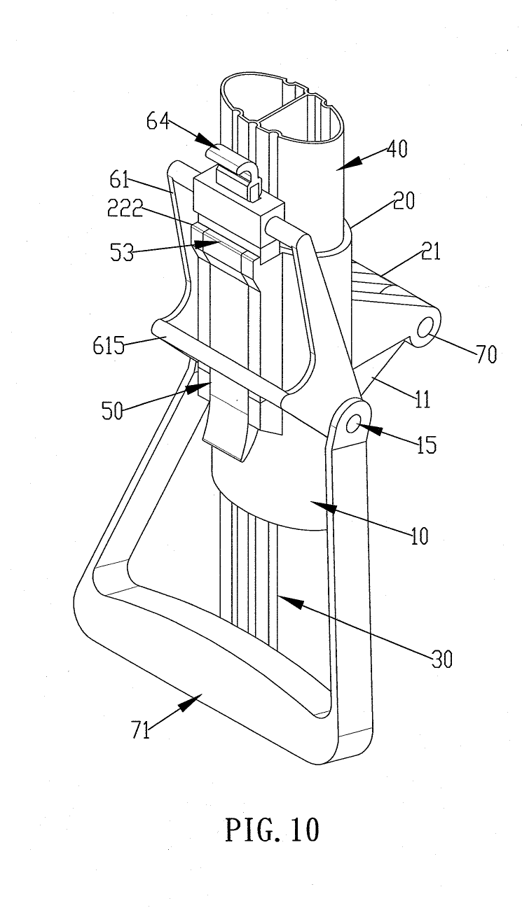

Referring to FIG. 10, the second tube 20 may have a third block 222 which is located on two sides of the first block 53 such that the third connection member 62 is located behind the first block 53 and the third block 222. A transverse bar 615 is connected to the second connection member 61 and located close to the first through holes 611 and contacts the first connection member 50. By this way, the first connection member 50 is protected and prevented from lifted accidentally.

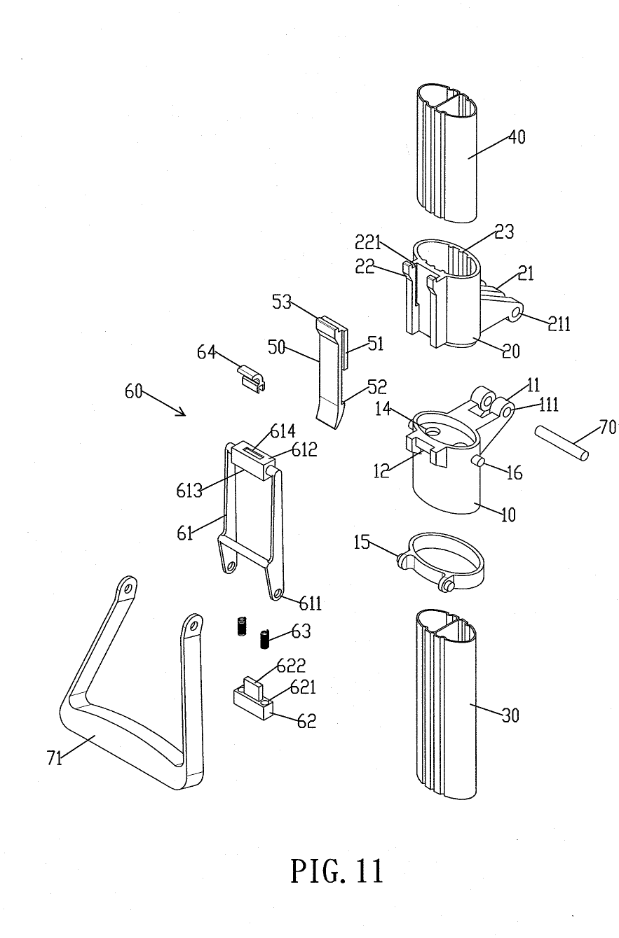

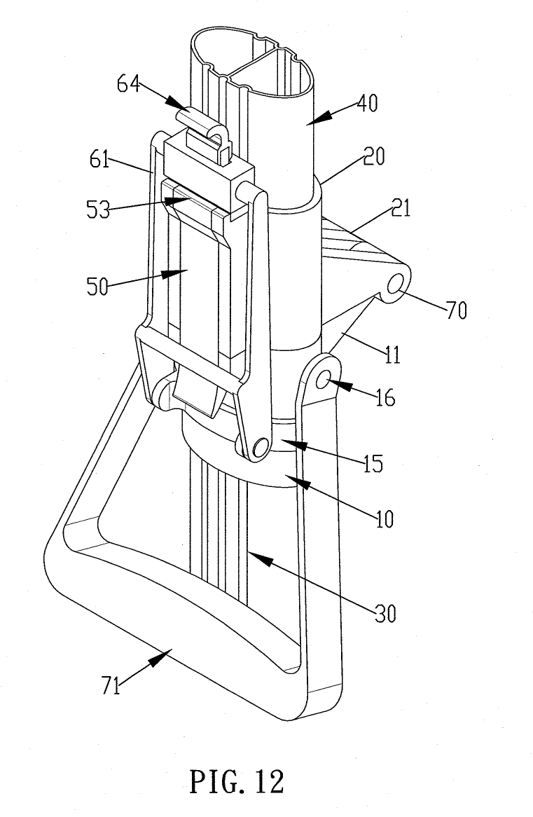

Referring to FIGS. 11 and 12, first pivots 51 can be formed on an independent part such as a ring which is mounted to the first tube 10 and located beneath the first engaging portion 12. Two second pivots 16 extend from the first tube 10 and the handle 71 is connected to the two pivots 16.

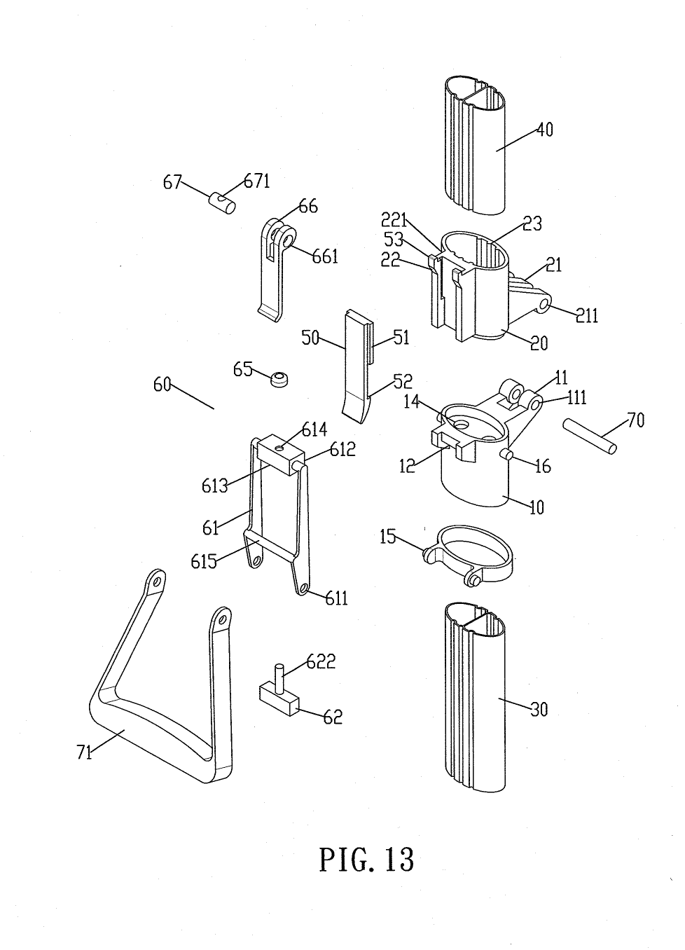

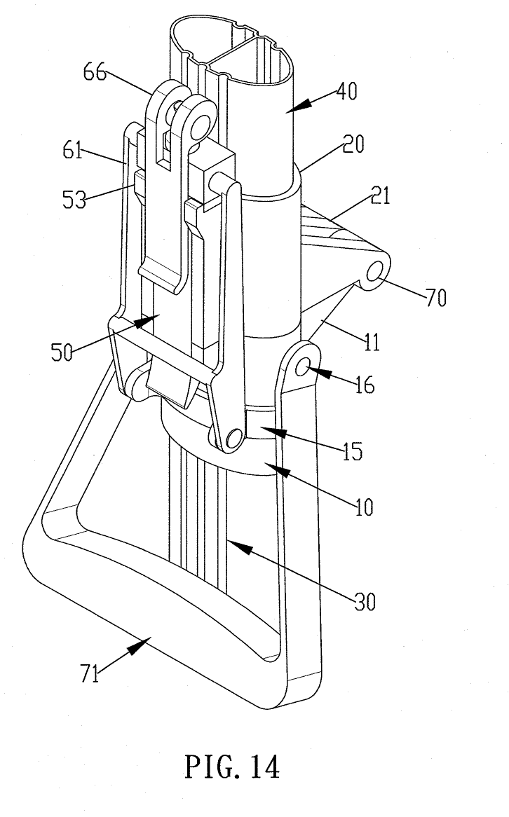

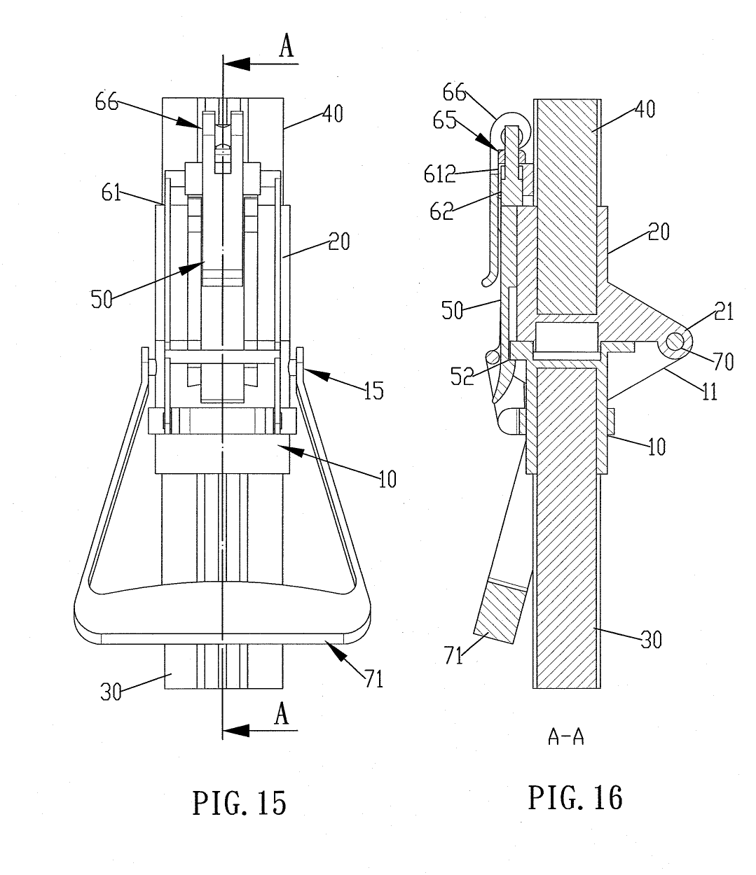

Referring to FIGS. 13 to 17, the second recess 614 of the second block 612 can be a circular recess and the third connection member 62 includes a protrusion 622 which is a rod with circular cross section and extends through first and second recesses 613, 614 of the second block 612. A pad 65 has an aperture defined centrally therethrough and is rested on the top of the second recess 614 and the protrusion 622 extends through the aperture of the pad 65.

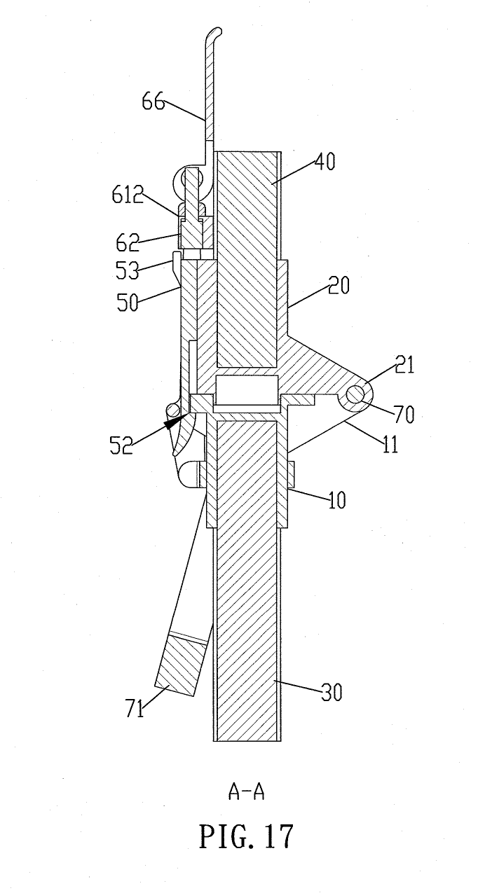

A fifth connection member 66 has an eccentric end and a second through hole 661 defined transversely through the eccentric end, The fifth connection member 66 operates as a quick release device. A second pin 67 extends through the second through hole 661 and has a transverse hole 671, the protrusion 622 is fixed to the transverse hole 671. When the fifth connection member 66 is set at the position as shown in FIG. 16, the second block 612 is located at a lower position and in contact with the first connection member 50. When pivoting the fifth connection member 66 upward about the second pin 67 as shown in FIG. 17, the second block 612 is lifted and disengaged from the first connection member 50, so that the first and second tubes 10, 20 can be pivoted to fold the pole unit.

The first and third tubes 10, 30 can be a one-piece member, and/or the second and fourth tubes 20, 40 are a one-piece member.

While we have shown and described the embodiment in accordance with the present invention, it should be clear to those skilled in the art that further embodiments may be made without departing from the scope of the present invention.

What is claimed is:

1. A pole unit for a wheeled distance measuring device, comprising:
a first tube (10) having a first pivotable portion (11) and a first engaging portion (12) extending radially outward therefrom respectively, two first pivots (15) extending radially from the first tube in two opposite directions other than directions of the first pivotable portion (11) and the first engaging portion (12);
a second tube (20) having a second pivotable portion (21) and a second engaging portion (22) extending radially outward therefrom, the second pivotable portion (21) pivotably connected to the first pivotable portion (11), the second engaging portion (22) located corresponding to the first engaging portion (12);
a third tube (30) connected with the first tube (10);
a fourth tube (40) connected with the second tube (20);
a first connection member (50) connected to the second tube (20) and having a second hook (52) which is hooked with the first engaging portion (12) on the first tube (10), the first connection member (50) having a first block (53) on a top thereof and a space (531) defined between the first block (53) and the first tube (10), and
a connection mechanism (60) having a second connection member (61) and a third connection member (62), the second connection member (61) having two arms and each arm having a first through hole (611), the two first pivots (15) engaged with the two first through holes (611) in the two arms, a second block (612) connected between the two arms and having a first recess (613), the third connection member (62) engaged with the first recess (613) and movable within the space (531).

2. The pole unit as claimed in claim 1, wherein the first pivotable portion (11) of the first tube (10) includes a first passage (111) and the second pivotable portion (21) of the second tube (20) has a second passage (211), a first pin (70) extends through the first and second passages (111, 211) to pivotably connect the first tube (10) and the second tube (20).

3. The pole unit as claimed in claim 1, wherein the first pivotable portion (11) and the first engaging portion (12) extend in two opposite directions.

4. The pole unit as claimed in claim 1, wherein the first tube (10) includes a first groove (13) defined axially in an inner periphery thereof and two first holes (14) are defined through a top of the first tube (10), the first holes (14) communicate with the first groove (13).

5. The pole unit as claimed in claim 1, wherein the second engaging portion (22) has the same length as the second tube (20) and includes two engaging slots (221).

6. The pole unit as claimed in claim 4, wherein the second tube (20) includes a second groove (23) defined axially in an inner periphery thereof and two second holes (24) are defined through a bottom of the second tube (20), the two second holes (24) communicate with the second groove (23), the first and second grooves (13, 23) are in communication with each other and the first and second holes (14, 24) are located in alignment with each other.

7. The pole unit as claimed in claim 4, wherein the third tube (30) is inserted into the first tube (10) and engaged with the first groove (13).

8. The pole unit as claimed in claim 6, wherein the fourth tube (40) is inserted into the second tube (20) and engaged with the second groove (23).

9. The pole unit as claimed in claim 5, wherein the first connection member (50) has a first hook (51) which is hooked to the engaging slots (221) of the second engaging portion (22).

10. The pole unit as claimed in claim 1, wherein the second block (612) includes a second recess (614) defined in a top thereof and the second recess (614) is smaller than the first recess (613), the first and second recesses (613, 614) are in communication with each other.

11. The pole unit as claimed in claim 10, wherein the third connection member (62) includes two notches (621) on a top thereof and a protrusion (622) is located between the two notches (621), the protrusion (622) extends through first and second recesses (613, 614) of the second block (612), two springs (63) are engaged with the two notches (621) and contact an inner end of the first recess (613) so as to push the third connection member (62) toward the first connection member (50), a fourth connection member (64) is fixed on the protrusion (622) on the third connection member (62), and contacts a top of the second block (612), the third connection member (62) is pulled to disengage from the first connection member (50) by pulling the fourth connection member (64) upward.

12. The pole unit as claimed in claim 1, wherein a handle (71) is connected to the pivots (15) on the first tube (10) and includes two arms which are located on outside of the second connection member (61).

13. The pole unit as claimed in claim 1, wherein the second tube (20) has a third block (222) which is located on two sides of the first block (53) such that the third connection member (62) is located behind the first block (53) and the third block (222).

14. The pole unit as claimed in claim 1, wherein the second connection member (61) has a transverse bar (615) which is located close to the first through holes (611) and contacts the first connection member (50).

15. The pole unit as claimed in claim 1, wherein the first pivots (51) are formed on an independent part which is mounted to the first tube (10) and located beneath the first engaging portion (12).

16. The pole unit as claimed in claim 1, wherein two second pivots (16) extend from the first tube (10) and a handle (71) is connected to the two pivots (16).

17. The pole unit as claimed in claim 10, wherein the second recess (614) of the second block (612) is a circular recess.

18. The pole unit as claimed in claim 17, wherein the third connection member (62) includes a protrusion (622) which extends through first and second recesses (613, 614) of the second block (612), a pad (65) has an aperture defined centrally therethrough and is rested on the top of the second recess (614) and the protrusion (622) extends through the aperture of the pad (65), a fifth connection member (66) having an eccentric end and a second through hole (661) defined transversely through the eccentric end, a second pin (67) extends through the second through hole (661), a transverse hole (671) is defined through the second pin (67) and the protrusion (622) is fixed to the transverse hole (671).

19. The pole unit as claimed in claim 1, wherein the first and third tubes (10, 30) are a one-piece member.

20. The pole unit as claimed in claim 1, wherein the second and fourth tubes (20, 40) are a one-piece member.
